(19) United States
(12) Patent Application Publication
(10) Pub. No.: US 2024/0119018 A1
(43) Pub. Date: Apr. 11, 2024

(54) USB TRANSMISSION SYSTEM, EQUIPMENT, METHOD, AND PROGRAM

(71) Applicant: NIPPON TELEGRAPH AND TELEPHONE CORPORATION, Tokyo (JP)

(72) Inventors: Tatsuya FUKUI, Musashino-shi, Tokyo (JP); Toshihito FUJIWARA, Musashino-shi, Tokyo (JP); Hiroya ONO, Musashino-shi, Tokyo (JP); Ryota SHIINA, Musashino-shi, Tokyo (JP); Tomohiko IKEDA, Musashino-shi, Tokyo (JP)

(73) Assignee: NIPPON TELEGRAPH AND TELEPHONE CORPORATION, Tokyo (JP)

(21) Appl. No.: 18/276,239

(22) PCT Filed: Feb. 18, 2021
(86) PCT No.: PCT/JP2021/006111

§ 371 Date: Aug. 7, 2023

(51) Int. Cl. G06F 13/36

(52) U.S. Cl. CPC G06F 13/36; G06F 2213/0042

(57) ABSTRACT

An object of the present disclosure is to enable data collection from a plurality of USB devices installed at remote locations.

The present disclosure is a USB transmission system including: a device-side transmitter/receiver configured to transmit/receive data to/from a USB device; and a host-side transmitter/receiver configured to transmit/receive data to/from a USB host, in which each of the device-side transmitter/receiver and the host-side transmitter/receiver includes a data transmission/reception unit configured to transmit/receive a packet of a USB protocol layer via a data network, and the host-side transmitter/receiver includes a hub configured to transfer data to be transmitted/received by the data transmission/reception unit included in the host-side transmitter/receiver to the USB host.

### TECHNICAL FIELD

The present disclosure relates to USB communication between two locations.

### BACKGROUND ART

With the spread of IoT and AI, efforts to widely install various USB devices such as a universal serial bus (USB) sensor and a USB camera in remote locations and collect data generated from these devices have been expanded. In order to proceed with the above operation, it is necessary to establish a method for collecting information on a USB device at a remote location. In general, a computer connected to a USB device is installed in the vicinity of the USB device at a remote location, USB communication is terminated at the computer, information is interpreted, and the information obtained by the interpretation is transmitted over a network and collected by a server at the remote location.

In this configuration, in order to collect data from the USB device, software for transmitting/receiving data between the computer and the server is required. In the data transmission software on the computer side, it is necessary to interpret information by terminating extremely large-capacity USB communication such as 20 Gbps like USB 3.2 Gen 2×2, and thus, a very high-spec computer is required. A large number of USB devices are installed in a wide area, and thus, it is not realistic to install such a computer in the vicinity of each USB device. It is therefore desirable to adopt a configuration in which termination of the USB communication and interpretation of the obtained data are not performed by equipment on the USB device side.

In the USB device, settings of the device can be changed via a USB-IF. For example, the settings include resolution of a camera. However, in the present embodiment, the server and the USB device are not connected via the USB-IF, and only information on the USB device is collected via software, so that a state of the USB device cannot be controlled from the server side. Of course, it is possible to provide the data transmission software and the data reception software with a function of controlling the state of the USB device, but in that case, such a function needs to be provided for each of a large number of USB devices, which is not realistic. It is therefore desirable to adopt a configuration in which USB communication is transparently transmitted to the server.

A technology called USB/internet protocol (IP) that enables a server to use a USB device connected to a computer at a remote location is disclosed (see, for example, Non Patent Literature 1). In USB/IP, USB communication is terminated in USB/IP client software, data (USB Request Block) is extracted and transmitted to a remote USB/IP host, and the USB device is simulated using the data transmitted in the USB/IP host. By using the present technology, it is possible to create a state as if the USB device at the remote location were directly connected to the server, and the USB communication is transparently transmitted to the server.

In addition, a technology for transmitting a USB physical signal on an optical signal is disclosed (see, for example, Non Patent Literature 2). In the present technology, the USB physical signal is transmitted as it is, so that it is possible to create a state as if the USB device at the remote location were directly connected to the server, and the USB communication is transparently transmitted to the server. In addition, a USB optical transmitter/receiver transmits the USB physical signal as it is, equipment on the USB device side neither terminates USB communication nor interprets the data obtained by terminating the USB communication.

However, in Non Patent Literature 1, USB/IP software is configured to temporarily terminate USB communication, and thus, there is a problem that a computer in the vicinity of the USB device is required to perform high-speed processing.

In Non Patent Literature 2, a timer called Pending HP Timer exists in a link layer after USB 3.0, but a value of the timer is a very small value of about 10 μs although the value varies depending on the device. In this method of extending a physical layer of the USB, only about 1 km can be transmitted in view of speed of light. Furthermore, in Non Patent Literature 2, a connection relationship between the USB device and the server depends on a physical configuration. Specifically, in a case where two USB devices are connected to the USB optical transmitter/receiver installed on the device side, the two USB devices can only be connected to one server connected to the corresponding USB optical transmitter/receiver. In other words, in order to adopt a mode in which two USB devices in the same area are connected to another server, it is necessary to prepare two sets of corresponding USB optical transmitters/receivers.

### CITATION LIST

### Non Patent Literature

Non Patent Literature 1: Takahiro Hirofuchi, Eiji Kawai, Kazutoshi Fujikawa, and Hideki Sunahara: USB/IP—a Peripheral Bus Extension for Device Sharing over IP Network, Proceedings of the 2005 USENIX Annual Technical Conference, p. 47-60, Apr. 10-15, 2005, Anaheim, CA, USA. https://www.usenix.org/legacy/events/usenix05/tech/freenix/hirofuchi/hirofuchi.pdf
Non Patent Literature 2: “USB 3.0 Extender”, Bayes Technologies, http://bayt.co.jp/products/branded/usb extender/usb3/spectr a3022.html

### SUMMARY OF INVENTION

### Technical Problem

An object of the present disclosure is to enable data collection from a plurality of USB devices installed at remote locations.

### Solution to Problem

In the present disclosure, a host-side transmitter/receiver that operates as a USB hub is provided on a USB host side, and a device-side transmitter/receiver that operates as a downstream (DS) port of the USB hub is provided on a USB device side. Adopting a configuration in which packets of a USB protocol layer are exchanged between these transmitters/receivers via a data network enables remote transmission using a USB.

A USB transmission system of the present disclosure includes:
a device-side transmitter/receiver including a USB port connectable to a USB device; and
a host-side transmitter/receiver connectable to a USB host,
in which each of the device-side transmitter/receiver and the host-side transmitter/receiver includes a data transmission/reception unit configured to transmit/receive a packet of a USB protocol layer via a data network, and
the host-side transmitter/receiver includes a hub configured to transfer data to be transmitted/received by the data transmission/reception unit included in the host-side transmitter/receiver to the USB host.

A USB transmission apparatus of the present disclosure includes:
a USB port connectable to a USB device;
a downstream (DS) function unit configured to transmit/receive data to/from a USB device connected to the USB port; and
a data transmission/reception unit configured to perform transmission/reception with a host-side transmitter/receiver connected to a USB host via a data network,
in which if the DS function unit receives data from the USB device, the data transmission/reception unit generates a packet of a USB protocol layer storing the data and transmits the packet to the host-side transmitter/receiver, and
if the DS function unit receives a packet of a USB protocol layer from the host-side transmitter/receiver, the data transmission/reception unit transfers data stored in the packet to the DS function unit.

A USB transmission apparatus of the present disclosure includes:
an upstream (US) function unit configured to transmit/receive data to/from a USB host; and
a data transmission/reception unit configured to perform transmission/reception with a device-side transmitter/receiver provided with a USB port connectable to a USB device via a data network,
in which if the US function unit receives data from the USB host, the data transmission/reception unit generates a packet of a USB protocol layer storing the data and transmits the packet to the device-side transmitter/receiver, and
if the US function unit receives a packet of a USB protocol layer from the device-side transmitter/receiver, the data transmission/reception unit transfers data stored in the packet to the US function unit.

A USB transmission method of the present disclosure to be performed by a USB transmission system including:
a device-side transmitter/receiver provided with a USB port connectable to a USB device; and
a host-side transmitter/receiver connectable to a USB host,
the USB transmission method including:
the device-side transmitter/receiver and the host-side transmitter/receiver transmitting/receiving a packet of a USB protocol layer via a data network; and
a hub included in the host-side transmitter/receiver transferring data to be transmitted/received by a data transmission/reception unit included in the host-side transmitter/receiver to the USB host.

A program of the present disclosure is a program for causing a computer to be implemented as each functional unit included in an apparatus according to the present disclosure, and is a program for causing a computer to execute each step included in a method to be executed by the apparatus according to the present disclosure.

### Advantageous Effects of Invention

The present disclosure enables data collection from a plurality of USB devices installed at remote locations.

### BRIEF DESCRIPTION OF DRAWINGS

FIG. 1 illustrates a system configuration example of the present embodiment.

FIG. 2 illustrates a system configuration example of the present embodiment.

FIG. 3 illustrates a system configuration example of the present embodiment.

FIG. 4 illustrates a system configuration example of the present embodiment.

FIG. 5 illustrates a system configuration example of the present embodiment.

FIG. 6 illustrates a configuration example of a device-side transmitter/receiver 91.

FIG. 7 illustrates a configuration example of a host-side transmitter/receiver 93.

FIG. 8 illustrates a configuration example of an orchestrator 95.

FIG. 9 illustrates a configuration example of a transmitter/receiver information management unit.

FIG. 10 illustrates an example of a host connection completion notification.

FIG. 11 illustrates a configuration example of the transmitter/receiver information management unit.

FIG. 12 illustrates an example of a connection establishment sequence.

FIG. 13 illustrates an example of a USB port connection request.

FIG. 14 illustrates a configuration example of the transmitter/receiver information management unit.

FIG. 15 illustrates an example of a connection establishment request notification.

FIG. 16 illustrates a configuration example of a host-side connection information management unit.

FIG. 17 illustrates an example of a request for connection between transmitters/receivers.

FIG. 18 illustrates a configuration example of a device-side connection information management unit.

FIG. 19 illustrates an example of connection OK between the transmitters/receivers.

FIG. 20 illustrates a configuration example of a host-side connection information management unit.

FIG. 21 illustrates a configuration example of a DS status management unit.

FIG. 22 illustrates an example of connection establishment OK.

FIG. 23 illustrates an example of USB port connection OK.

FIG. 24 illustrates an example of a device connection sequence.

FIG. 25 illustrates an example of a USB device connection completion notification.

FIG. 26 illustrates an example of a port reset request.

FIG. 27 illustrates an example of port reset completion.

FIG. 28 illustrates an example of a method for transmitting a packet of a protocol layer in a USB.

FIG. 29 illustrates an example of a USB packet.

FIG. 30 illustrates an example of a USB packet.

FIG. 31 illustrates an example of a method for transmitting a packet of a protocol layer in a USB.

FIG. 32 illustrates an example of a USB packet.

FIG. 33 illustrates an example of a USB packet.

FIG. 34 illustrates an example of processing (OUT transaction) to be performed in the USB packet.

FIG. 35 illustrates an example of processing (IN transaction) to be performed in the USB packet.

### DESCRIPTION OF EMBODIMENTS

Hereinafter, embodiments of the present disclosure will be described in detail with reference to the drawings. The present disclosure is not limited to the embodiments described below. These embodiments are merely an example, and the present disclosure can be carried out in forms with various modifications and improvements based on knowledge of those skilled in the art. Note that components having the same reference numerals in the present specification and the drawings indicate the same components.

### First Embodiment

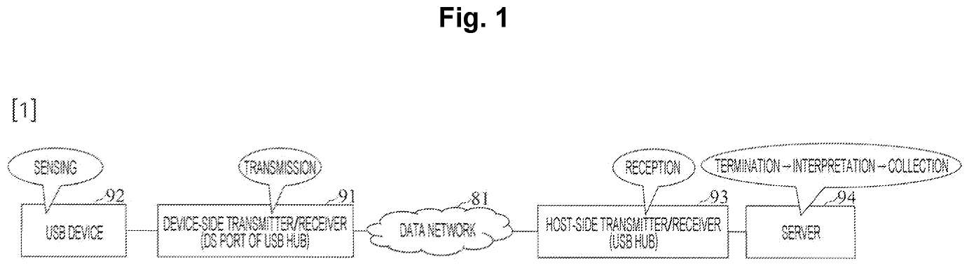

FIG. 1 illustrates a system configuration example of the present embodiment. In a USB transmission system of the present embodiment, a device-side transmitter/receiver 91 is connected between a network 81 and a USB device 92, and a host-side transmitter/receiver 93 is connected between the data network 81 and a server 94. As described above, the present embodiment employs a configuration in which the host-side transmitter/receiver 93 that operates as a USB hub is provided on the USB host side, the device-side transmitter/receiver 91 that operates as a downstream (DS) port of the USB hub is provided on the USB device side, and packets of the USB protocol layer are exchanged between the transmitters/receivers via the data network 81.

The USB transmission system of the present embodiment adopting the present configuration enables termination in the server 94 and does not terminate USB communication in the device-side transmitter/receiver 91, so that it is possible to adopt a configuration in which USB communication between the USB device 92 and the server 94 at a remote location is transparently transmitted without installing a high-spec computer in the vicinity of the USB device 92. Furthermore, by adopting the present configuration, it is possible to extend USB communication between two remote locations without depending on a timer of a link layer in USB 3.0.

### Second Embodiment

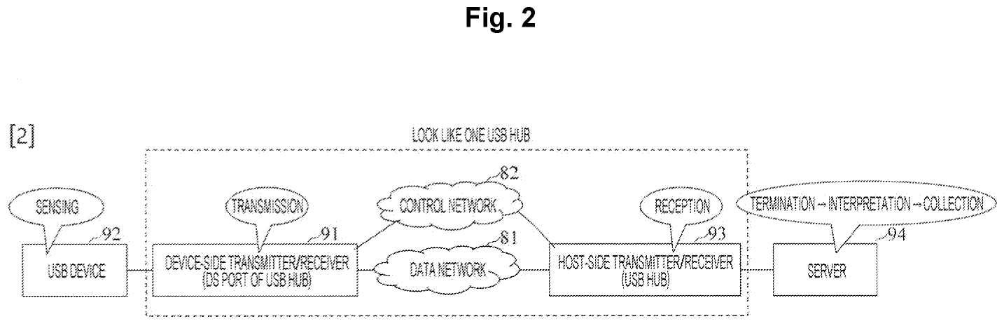

FIG. 2 illustrates a system configuration example of the present embodiment. A USB transmission system of the present embodiment exchanges between the host-side transmitter/receiver 93 and the device-side transmitter/receiver 91 via a control network 82 that is the same as or different from the data network 81, at least one of:
a connection state with the server 94, that is, the USB host in the host-side transmitter/receiver 93,
a connection state with the USB device in the device-side transmitter/receiver 91, or
a connection establishment state between the host-side transmitter/receiver 93 and the device-side transmitter/receiver 91, and
determines operation of the device-side transmitter/receiver 91 and the host-side transmitter/receiver 93 on the basis of these states.

In the USB transmission system of the present embodiment adopting the present configuration, the USB hub and the DS port of the USB hub can exchange the states with each other, so that the whole of the USB hub and the DS port of the USB hub, which are physically separated from each other, can be seen from the server 94 and the USB device 92 as if the USB hub and the DS port operated as a general USB hub.

### Third Embodiment

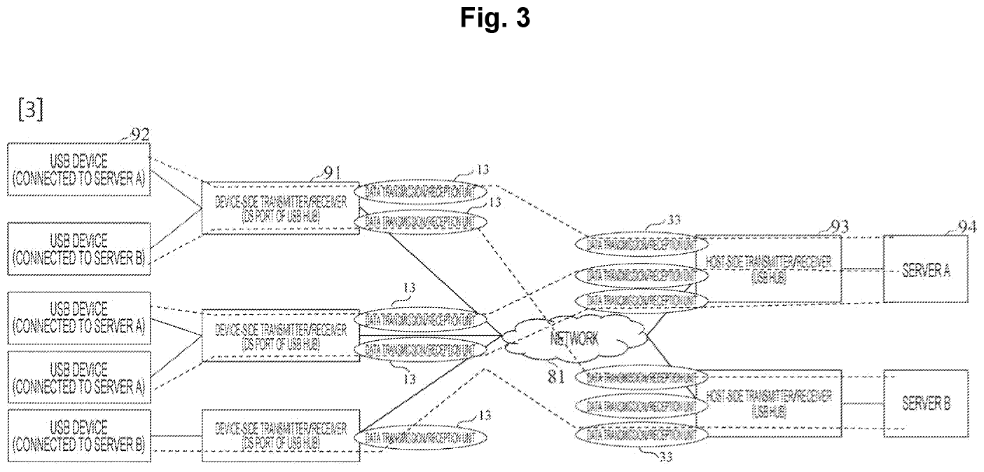

FIG. 3 illustrates a system configuration example of the present embodiment. A USB transmission system according to the present embodiment includes a data transmission/reception unit 13 that corresponds to the USB port of the device-side transmitter/receiver 91 on a one-to-one basis in the device-side transmitter/receiver 91, and a data transmission/reception unit 33 that corresponds to the DS port of the host-side transmitter/receiver 91 on a one-to-one basis in the host-side transmitter/receiver 93,
in which the device-side transmitter/receiver 91 and the host-side transmitter/receiver 93 include a table for controlling a connection relationship between these data transmission/reception units, and
a connection relationship between the data transmission/reception units 13 and 33 is established on the basis of description of the table.

The USB transmission system of the present embodiment can freely change the connection relationship between the server 94 and the USB device 92 via the data network 81 by adopting the present configuration.

### Fourth Embodiment

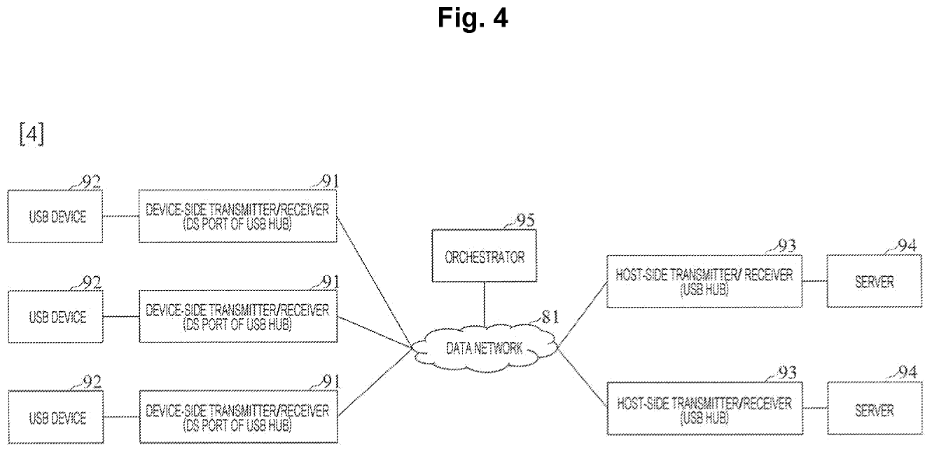

FIG. 4 illustrates a system configuration example of the present embodiment. A USB transmission system of the present embodiment has a configuration in which the table for controlling the connection relationship between the data transmission/reception units 31 and 33 described in the third embodiment can be controlled by an orchestrator 95.

The USB transmission system of the present embodiment adopting the present configuration can access the orchestrator 95 using software, so that the connection relationship between the USB device 92 and the server 94 can be controlled via software.

(Effects of Present Disclosure)

The USB transmission system of the present disclosure can adopt the system configuration described in the first to fourth embodiments described above. The device-side transmitter/receiver 91 and the host-side transmitter/receiver 93 function as the USB transmission apparatus of the present disclosure. The present disclosure can obtain the following effects by adopting the system configuration of any one of the first to fourth embodiments.
The USB device 92 at the remote location can be directly connected to the server 94 without intervention of software processing.
The plurality of USB ports included in the device-side transmitter/receiver 91 can be connected to the USB hubs of the plurality of different host-side transmitter/receivers 93, so that it is possible to freely change the connection relationship between the USB device 92 and the server 94.

Note that the present disclosure does not depend on the modes described in the embodiments.

For example, a user datagram protocol (UDP)/IP is used as the data transmission/reception units 13 and 33, but the present disclosure is not limited thereto. For example, a technology such as Ethernet (registered trademark), multi-protocol label switching (MPLS), or optical transport network (OTN) may be used.

Furthermore, the server 94 may be any apparatus that collects information of the USB device 92. In the present disclosure, an arbitrary apparatus that collects information of the USB device 92 is referred to as a “USB host”.

In addition, the orchestrator 95 may manage all the states of the host-side transmitter/receiver 93 and the device-side transmitter/receiver 91.

### Fifth Embodiment

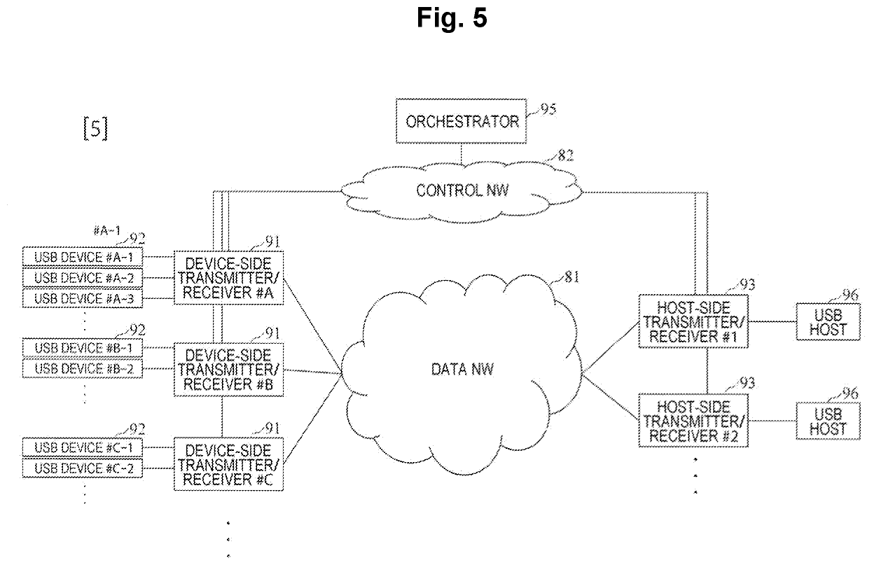

In the present embodiment, details of the configuration of the present disclosure will be described. FIG. 5 illustrates a system configuration example of the present embodiment. A system of the present embodiment has the configuration described in the third and fourth embodiments. Specifically, the device-side transmitter/receiver 91 and the host-side transmitter/receiver 93 are connected to each other by the data network 81 and are connected to the orchestrator 95 via the control network 82.

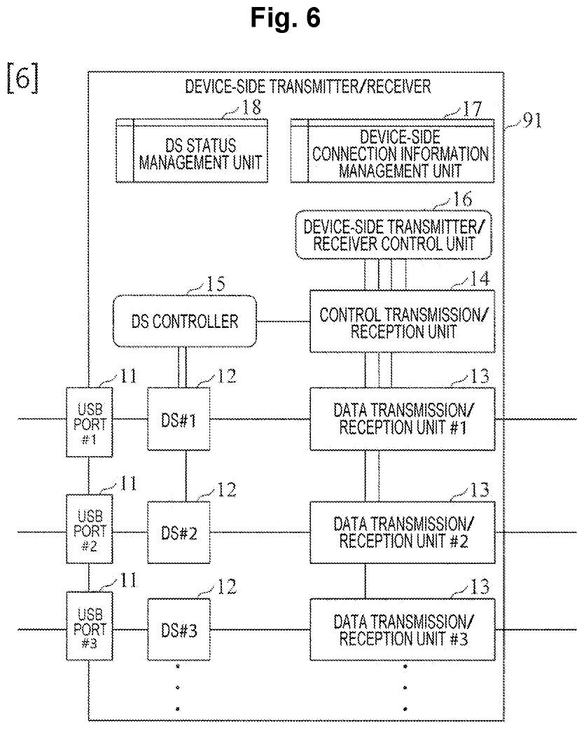

FIG. 6 illustrates a configuration example of the device-side transmitter/receiver 91. The device-side transmitter/receiver 91 includes the USB port 11, the DS 12 that operates as the DS function unit, the data transmission/reception unit 13, a control transmission/reception unit 14, a DS controller 15, a device-side transmitter/receiver control unit 16, a device-side connection information management unit 17, and a DS status management unit 18. The device-side transmitter/receiver 91 can also be implemented by a computer and a program, and the program can be recorded in a recording medium or provided through a network.

The USB port 11 is a port connected to the USB device 92. The device-side connection information management unit 17 manages device-side connection information indicating a connection relationship between the device-side transmitter/receiver 91 and the host-side transmitter/receiver 93. The DS status management unit 18 manages a connection state with the USB device 92 for each USB port 11.

The DS 12 is provided for each USB port 11 and transmits/receives packets to/from the USB device 92. The data transmission/reception unit 13 is provided for each USB port 11 and transmits/receives data to/from the host-side transmitter/receiver 93 as a connection destination. The DS status management unit 18 manages a connection state between each data transmission/reception unit 13 and the data transmission/reception unit 33.

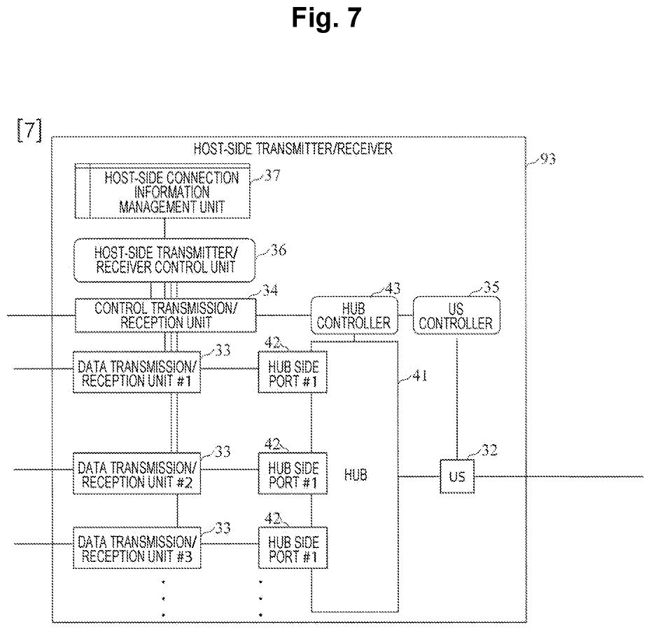

FIG. 7 illustrates a configuration example of the host-side transmitter/receiver 93. The host-side transmitter/receiver 93 includes a US 32 that operates as a US function unit, a data transmission/reception unit 33, a control transmission/reception unit 34, a US controller 35, a host-side transmitter/receiver control unit 36, a host-side connection information management unit 37, a hub 41, a hub side port 42, and a hub controller 43. The host-side transmitter/receiver 93 can also be implemented with a computer and a program, and the program can be recorded in a recording medium or provided through a network.

The US 32 transmits/receives data to/from the USB host 96. The hub 41 is connected to the US 32, is connected to the data transmission/reception unit 33 via the hub side port 42 and functions as a USB hub. The data transmission/reception unit 33 is provided for each of the hub side ports 42 and transmits/receives data to/from the device-side transmitter/receiver 91 as a connection destination.

The host-side connection information management unit 37 manages host-side connection information indicating a connection relationship between the host-side transmitter/receiver 93 and the device-side transmitter/receiver 91. The host-side connection information includes a hub side port number, data transmission/reception unit information, connection destination transmitter/receiver information, connection destination transmitter/receiver port number information, connection destination control transmission/reception unit information, and connection destination data transmission/reception unit information. The data transmission/reception unit information is identification information of the data transmission/reception unit 33. The connection destination transmitter/receiver information is identification information of the device-side transmitter/receiver 91 of the connection destination. The connection destination transmitter/receiver port number information is a port number in the device-side transmitter/receiver 91 of the connection destination. The connection destination control transmission/reception unit information is identification information of the control transmission/reception unit in the device-side transmitter/receiver 91 of the connection destination. The connection destination data transmission/reception unit information is identification information of the data transmission/reception unit 13 in the device-side transmitter/receiver 91 of the connection destination. The identification information in the present disclosure is arbitrary information unique in the USB transmission system and may be a number or an IP address.

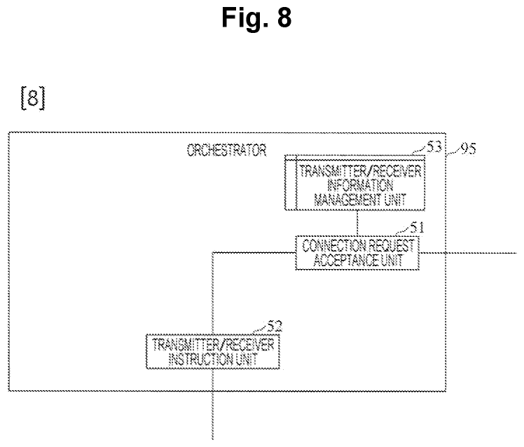

FIG. 8 illustrates a configuration example of the orchestrator 95. The orchestrator 95 includes a connection request acceptance unit 51, a transmitter/receiver instruction unit 52, and a transmitter/receiver information management unit 53.

The connection request acceptance unit 51 accepts a USB port connection request. The USB port connection request can be transmitted to the orchestrator 95 from any apparatus from a user, or the like, in addition to the device-side transmitter/receiver 91 and the host-side transmitter/receiver 93 by using software, or the like.

The transmitter/receiver instruction unit 52 is connected to the device-side transmitter/receiver 91 and the host-side transmitter/receiver 93 and provides information regarding establishment of connection to at least one of the device-side transmitter/receiver 91 or the host-side transmitter/receiver 93. This information is, for example, a connection establishment request, an instruction, or a notification of completion.

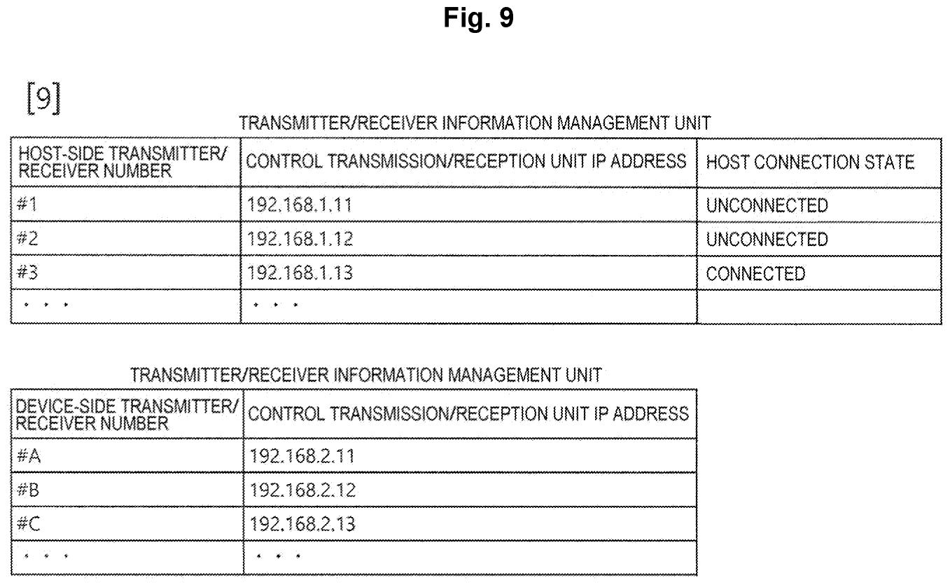

The transmitter/receiver information management unit 53 stores information on the host-side transmitter/receiver 93 and the device-side transmitter/receiver 91. FIG. 9 illustrates an example of the transmitter/receiver information management unit. The information on the host-side transmitter/receiver 93 includes, for example, a host-side transmitter/receiver number indicating identification information of the host-side transmitter/receiver 93, a control transmission/reception unit IP address indicating identification information of the control transmission/reception unit 34, and a host connection state indicating a connection state with the USB host 96. The information on the device-side transmitter/receiver 91 includes a device-side transmitter/receiver number indicating identification information of the device-side transmitter/receiver 91 and a control transmission/reception unit IP address indicating identification information of the control transmission/reception unit 14. The information on the device-side transmitter/receiver 91 may include a connection state of each USB port 11 with the USB device 92.

The control transmission/reception unit 14 included in the device-side transmitter/receiver 91 and 34 included in the host-side transmitter/receiver 93 exchange the information described in the second embodiment with each other via the control network 82.

The DS controller 15 controls the DS 12 on the basis of the information transmitted/received by the control transmission/reception unit 14. The device-side transmitter/receiver control unit 16 controls the data transmission/reception unit 13 on the basis of the information transmitted/received by the control transmission/reception unit 14.

The hub controller 43 controls the hub 41 on the basis of the information transmitted/received by the control transmission/reception unit 34. The US controller 35 controls the US 32 on the basis of the information transmitted/received by the control transmission/reception unit 34. The host-side transmitter/receiver control unit 36 controls the data transmission/reception unit 33 on the basis of the information transmitted/received by the control transmission/reception unit 34.

In the system configuration illustrated in FIG. 5, examples when the USB device 92 is connected to the host-side transmitter/receiver 93 and performs communication are roughly divided into:
(1) host connection sequence
(2) connection establishment sequence
(3) device connection sequence. Each sequence in a case where a USB device 92 #A-3 connected to a USB port 11 #3 of a device-side transmitter/receiver 91 #2 is connected to a host-side transmitter/receiver 93 #2 will be described below.

(1) Host Connection Sequence

A user connects the host-side transmitter/receiver 93 #2 to the USB host 96. The hub controller 43 and the US controller 35 of the host-side transmitter/receiver 93 #2 at this time perform connection processing equivalent to that of a normal USB hub.

If the connection processing with the USB host 96 is completed, the hub controller 43 of the host-side transmitter/receiver 93 #2 notifies the host-side transmitter/receiver control unit 36 of completion of the connection with the USB host 96.

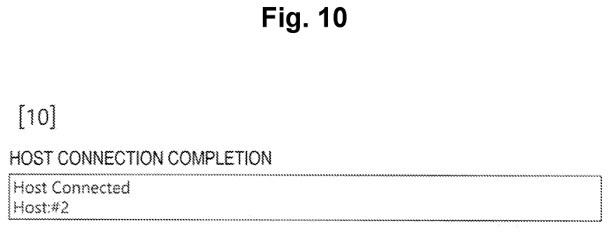

The host-side transmitter/receiver control unit 36 transmits a host connection completion notification to the transmitter/receiver instruction unit 52 of the orchestrator 95 (S101). FIG. 10 illustrates an example of the host connection completion notification. The host connection completion notification includes identification information “#2” of the host-side transmitter/receiver 93.

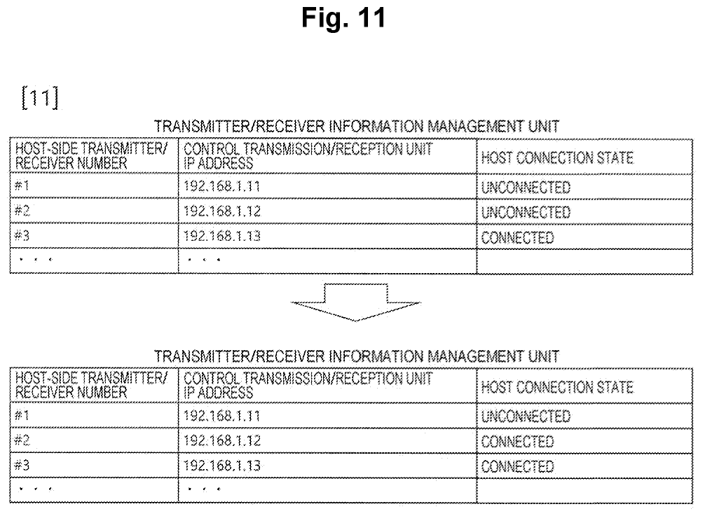

Upon receiving the host connection completion, the orchestrator 95 updates the transmitter/receiver information management unit 53. For example, as illustrated in FIG. 11, a host connection state of the host-side transmitter/receiver number “#2” is updated from “unconnected” to “connected”.

(2) Connection Establishment Sequence

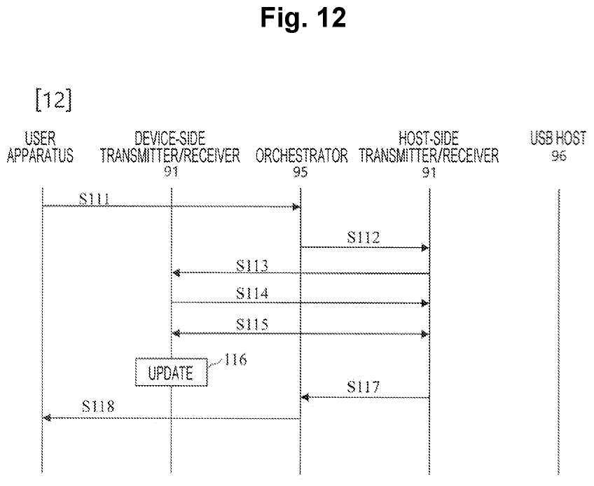

A connection establishment sequence between the host-side transmitter/receiver 93 and the USB device 92 will be described with reference to FIG. 12.

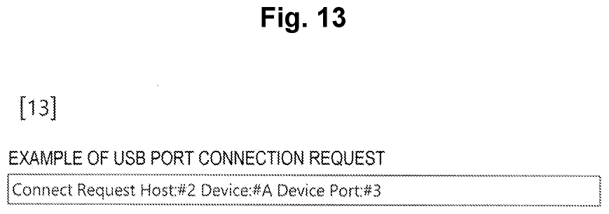

The user transmits a USB port connection request to the orchestrator 95 using software. FIG. 13 illustrates an example of the USB port connection request. The USB port connection request includes identification information “#2” of the host-side transmitter/receiver 93, identification information “#A” of the device-side transmitter/receiver 91, and identification information “#3” of the USB port 11.

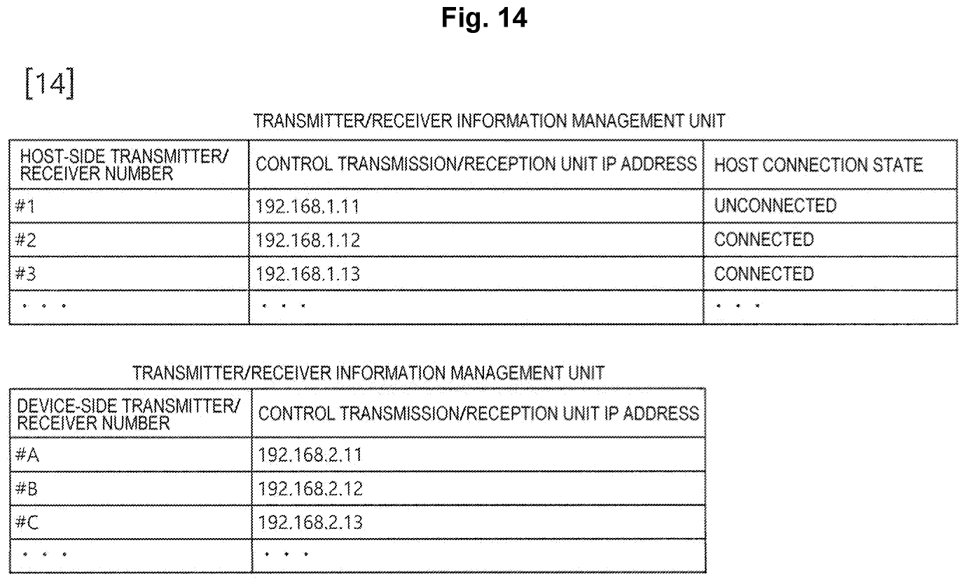

The connection request acceptance unit 51 of the orchestrator 95 accepts the USB port connection request from the user, or the like (S111) and notifies the transmitter/receiver instruction unit 52 of the USB port connection request. The transmitter/receiver instruction unit 52 of the orchestrator 95 refers to the transmitter/receiver information management unit 53, and if the host connection state of the host-side transmitter/receiver 93 for which a connection has been requested is “connected”, transmits a connection establishment request to the host-side transmitter/receiver 93 (S112). In the present embodiment, as illustrated in FIG. 14, the host connection state of the host-side transmitter/receiver 93 #2 is “connected”, and thus, a “connection establishment request” is transmitted to the host-side transmitter/receiver 93.

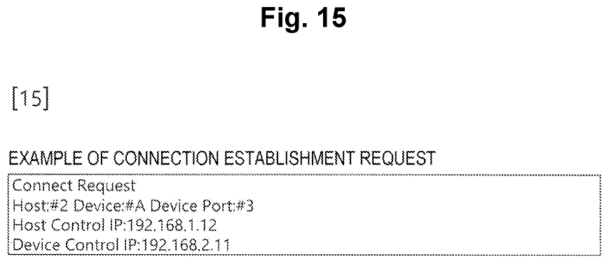

FIG. 15 illustrates an example of a connection establishment request notification. The connection establishment request notification includes the identification information “#2” of the host-side transmitter/receiver 93, the IP address of the control transmission/reception unit 24 of the host-side transmitter/receiver 93, the identification information “#A” of the device-side transmitter/receiver 91, the port number “#3” of the device-side transmitter/receiver 91, and the IP address of the control transmission/reception unit 14 of the device-side transmitter/receiver 91.

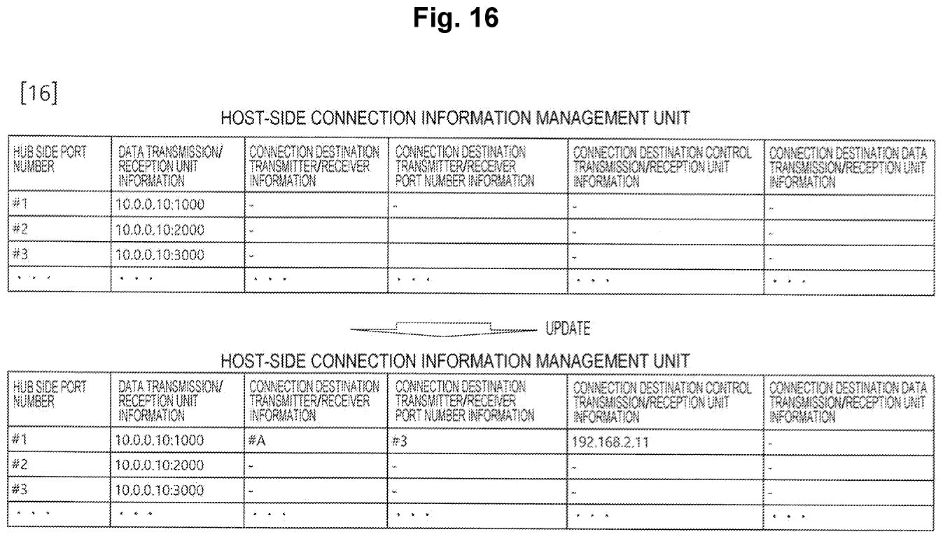

The host-side transmitter/receiver control unit 36 of the host-side transmitter/receiver 93 selects the data transmission/reception unit 33 to be used for connection on the basis of the host-side connection information management unit 37 and updates the host-side connection information management unit 37. For example, as illustrated in FIG. 16, in a case where the hub side port #1 of the host-side transmitter/receiver 93 #2 is connected to the USB device 92 #A-3 of the device-side transmitter/receiver 91 #A, the identification information “#A” of the device-side transmitter/receiver 91, the port number information “#3” of the connection destination, and the IP address “192.168.2.11” of the control transmission/reception unit 14 of the connection destination are stored in association with the identification information of the hub side port #1 and the data transmission/reception unit 33 #1.

Here, the data transmission/reception unit 33 may be selected using any method, and for example, the data transmission/reception unit 33 that is not used may be selected in order from the top. If all the data transmission/reception units 33 are unavailable, the orchestrator 95 is notified of a “connection establishment NG notification” indicating that connection cannot be established.

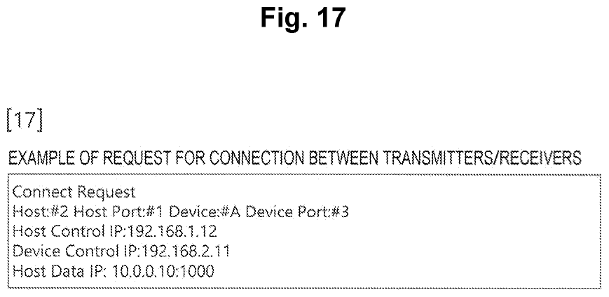

The host-side transmitter/receiver control unit 36 adds identification information of the selected data transmission/reception unit 33 and transmits a request for connection between the transmitters/receivers to the device-side transmitter/receiver 91 (S113). For example, in a case where the data transmission/reception unit 33 #1 of the host-side transmitter/receiver 93 #2 is selected, the IP address “10.0.0.10:1000” of the data transmission/reception unit 33 #1 is added to the request for connection between the transmitters/receivers as illustrated in FIG. 17.

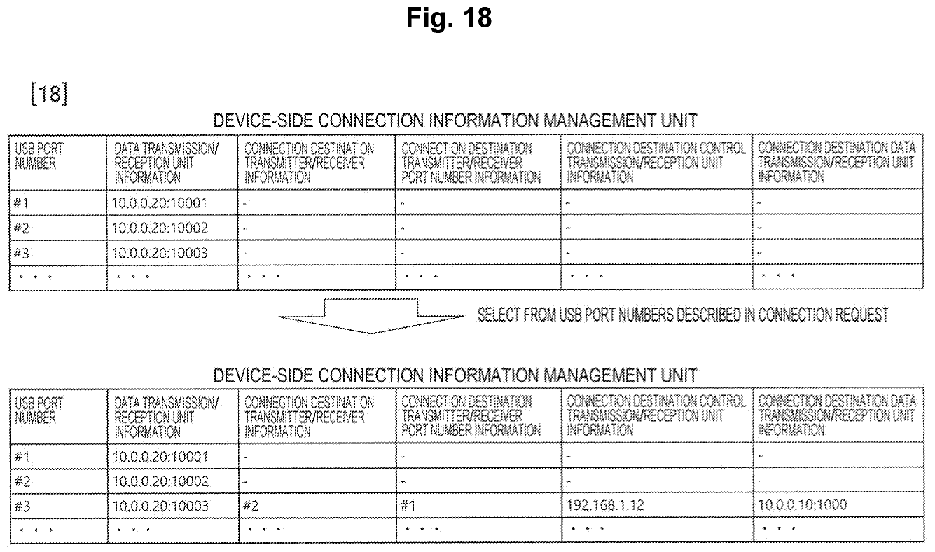

If the USB port number to be connected described in the received connection request is in an unused state, the device-side transmitter/receiver control unit 16 of the device-side transmitter/receiver 91 updates the device-side connection information management unit 17. For example, as illustrated in FIG. 18, the identification information “#2” of the host-side transmitter/receiver 93, the port number “#1” of the host-side transmitter/receiver 93 of the connection destination, and the IP address “10.0.0.10:1000” of the data transmission/reception unit 33 of the connection destination are stored in the connection destination transmitter/receiver information of the USB port number #3. In this event, the IP address “192.168.1.12” of the control transmission/reception unit 34 of the host-side transmitter/receiver 93 of the connection destination may also be associated.

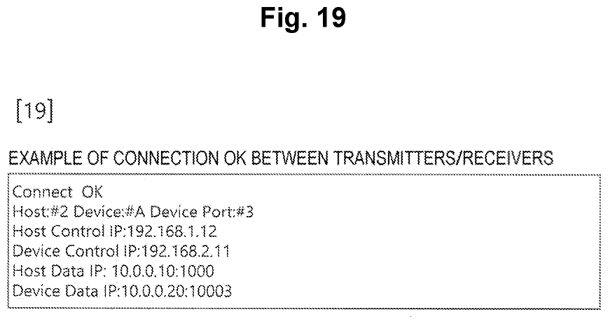

The device-side transmitter/receiver control unit 16 adds the data transmission/reception unit information and transmits a connection OK between the transmitters/receivers to the host-side transmitter/receiver 93 (S114). FIG. 19 illustrates an example of a notification of connection OK between the transmitters/receivers. The notification of connection OK between the transmitters/receivers includes an IP address “10.0.0.20:10003” of the data transmission/reception unit 13 as the information of the data transmission/reception unit 13.

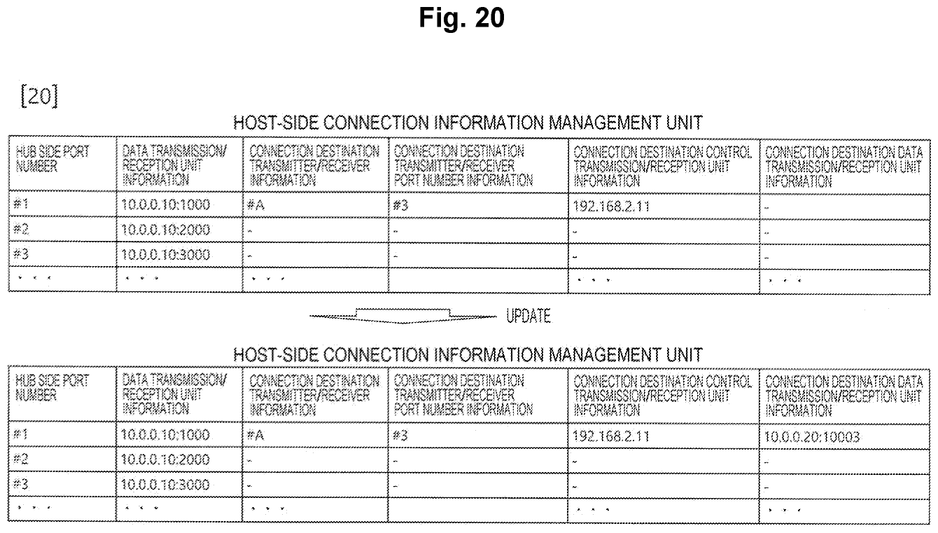

The host-side transmitter/receiver control unit 36 updates the information of the host-side connection information management unit 37 on the basis of the connection OK between the transmitters/receivers from the device-side transmitter/receiver control unit 16. For example, as illustrated in FIG. 20, the IP address “10.0.0.20:10003” of the data transmission/reception unit 13 connected to the hub side port #1 is stored in association with the hub side port #1.

The host-side data transmission/reception unit 33 and the device-side data transmission/reception unit 13 establish a connection on the basis of the information of the host-side connection information management unit 37 and the device-side connection information management unit 17, respectively (S115). Here, a connection may be established using any method, and for example, transmission control protocol (TCP) is used to establish a TCP connection, security architecture for Internet protocol (IPsec) is used to establish an IPsec connection, UDP Socket is used to establish a UDP socket and exchange a test packet, and the like.

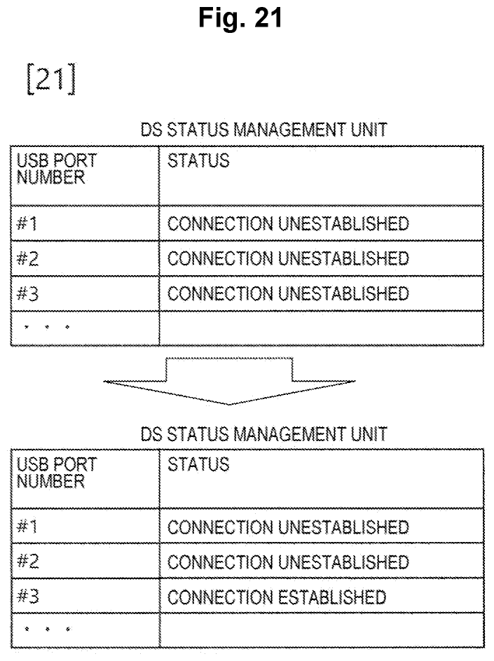

The device-side transmitter/receiver control unit 16 updates the DS status management unit 18 when the connection is established (S116). In the present embodiment, the connection of the USB port number #3 has been established, and thus, a status of the USB port number #3 is updated to “connection established” as illustrated in FIG. 21.

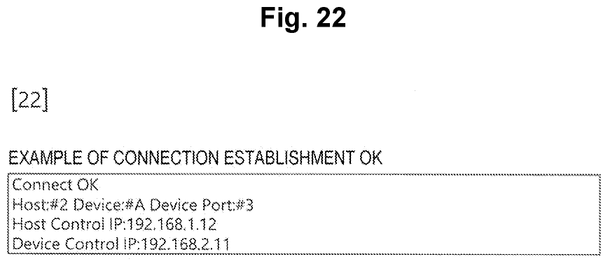

The host-side transmitter/receiver control unit 36 transmits a connection establishment OK notification to the transmitter/receiver instruction unit 52 of the orchestrator 95 when the connection is established (S117). FIG. 22 illustrates an example of the connection establishment OK notification. The connection establishment OK notification includes the identification information “#2” of the host-side transmitter/receiver 93, the identification information “#A” of the device-side transmitter/receiver 91, the port number “#3” of the device-side transmitter/receiver 91, the IP address of the control transmission/reception unit 24 of the host-side transmitter/receiver 93, and the IP address of the control transmission/reception unit 14 of the device-side transmitter/receiver 91.

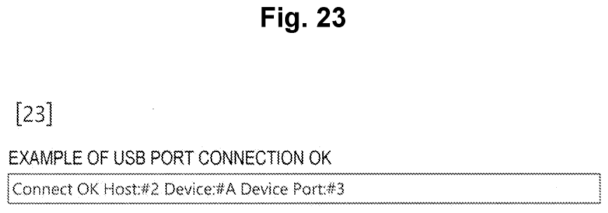

Upon receiving the connection establishment OK notification, the transmitter/receiver instruction unit 52 of the orchestrator 95 notifies the connection request acceptance unit 51 that the connection has been completed. The connection request acceptance unit 51 of the orchestrator 95 gives a notification of a USB port connection request OK in response to a connection request from the user, or the like (S118). FIG. 23 illustrates an example of the USB port connection request OK notification. The USB port connection request OK notification includes the identification information “#2” of the host-side transmitter/receiver 93, the identification information “#A” of the device-side transmitter/receiver 91, and the port number “#3” of the device-side transmitter/receiver 91.

(3) Device Connection Sequence

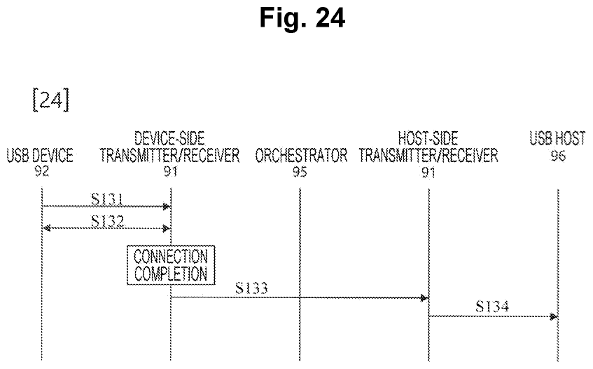

The device connection sequence will be described with reference to FIG. 24.

The USB device 92 is connected to the USB port 11 of the device-side transmitter/receiver 91 (S131).

Upon detecting the connection of the USB device 92, the DS controller 15 of the device-side transmitter/receiver 91 refers to the DS status management unit 18, and if the status of the USB port is connection established, controls the DS 12 and starts power supply. Here, in a case where the connection is not established, the power supply is not performed.

Link training and port configuration are performed between the USB device 92 and the device-side transmitter/receiver 91 (S132), for example, in accordance with USB 3.2 Revision 1.0 7.5 Link Training and Status State Machine (LTSSM).

When the port configuration is completed and the USB device 92 is put into a default state, the DS controller 15 of the device-side transmitter/receiver 91 notifies the device-side transmitter/receiver control unit 16 of completion of the USB device connection of the USB port 11.

The device-side transmitter/receiver control unit 16 refers to the device-side connection information management unit 17 and transmits a USB device connection completion notification to the destination described in the connection destination control transmission/reception unit information of the port number to which the USB device 92 is connected (S133). For example, in a case where the USB device 92 is connected to the USB port number #3, the USB device connection completion notification is transmitted to the IP address “192.168.1.12” described in the connection destination control transmission/reception unit information illustrated in FIG. 18. As a result, the USB device connection completion notification is transmitted to the control transmission/reception unit 34 of the host-side transmitter/receiver 93 #2.

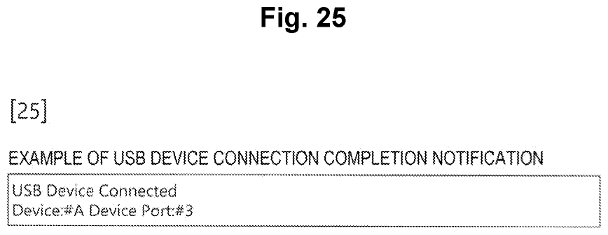

FIG. 25 illustrates an example of the USB device connection completion notification. The USB device connection completion notification includes information indicating that the connection of the USB device is completed, connection destination transmitter/receiver information, and connection destination transmitter/receiver port number information. The connection destination transmitter/receiver information is the identification information “#A” of the device-side transmitter/receiver 91, and the connection destination transmitter/receiver port number information is the port number “#3” to which the USB device 92 is connected.

The host-side transmitter/receiver control unit 36 refers to the host-side connection information management unit 37 to derive the corresponding hub side port number from the connection destination transmitter/receiver information and the connection destination transmitter/receiver port number information described in the received USB device connection completion notification and notifies the hub controller 43 of change in a state of the hub side port using the derived hub side port number. For example, as illustrated in FIG. 20, in the host-side connection information management unit 37, the identification information #A of the device-side transmitter/receiver 91 is described in the connection destination transmitter/receiver information, the port number information #3 is described in the connection destination transmitter/receiver port number information, and these are associated with the hub side port #1. In this case, the hub controller 43 is notified that the hub side port #1 is in the connection state.

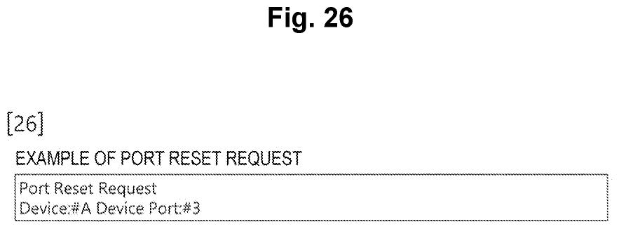

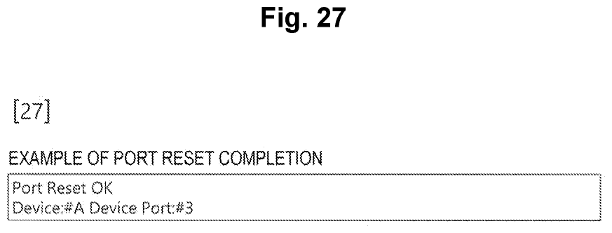

The hub controller 43 controls the hub 41 to start bus enumeration with the USB host 96 by being triggered by notification of the change in the state of the hub side port. The USB host 96 and the hub 41 perform communication in accordance with content described in USB 3.2 Revision 1.0 9.1.2 Bus Enumeration. A method for transmitting a packet of a protocol layer in the USB to be exchanged between the USB host 96 and the USB device 92 will be described later.
Step S41: The hub 41 notifies the USB host 96 of occurrence of an event of device insertion/extraction. In this event, the hub side port number (#1 in this example) is used as the port number at which the event occurs.
Step S42: The USB host 96 inquires of the hub 41 about change in a status, and the hub 41 returns content of the change in the status to the USB host 96.
Step S43: The USB host 96 resets the connected USB device 92 as necessary.
Step S44-1: In a case where the USB device 92 is reset in step S43, the hub 41 resets its own hub side port 42 and notifies the hub controller 43 of the reset.
Step S44-2: The hub controller 43 refers to the host-side connection information management unit 37 to guide the connection destination transmitter/receiver information, the connection destination transmitter/receiver port number information, and the connection destination control transmission/reception unit information corresponding to the hub side port number to which the USB device 92 that has been reset belongs and transmits a port reset request of the connection destination transmitter/receiver port number to a destination of the connection destination control transmission/reception unit information. FIG. 26 illustrates an example of the port reset request.
Step S44-3: The device-side transmitter/receiver control unit 16 resets the USB port 11 requested to the DS controller 15.
Step S44-4: Link training and port configuration are performed between the USB device 92 and the device-side transmitter/receiver 91.
Step S44-5: The DS controller 15 of the device-side transmitter/receiver 91 notifies the device-side transmitter/receiver control unit 16 of completion of the USB device connection of the USB port 11 when the port configuration is completed and the USB device 92 is put into a default state.
Step S44-6: The device-side transmitter/receiver control unit 16 refers to the device-side connection information management unit 17 to notify the destination described in the connection destination control transmission/reception unit information of the port number to which the USB device 92 is connected of completion of the port reset. FIG. 27 illustrates an example of completion of the port reset.

The rest of the description is identical to section 5 and subsequent sections of USB 3.2 Revision 1.0 9.1.2 Bus Enumeration.

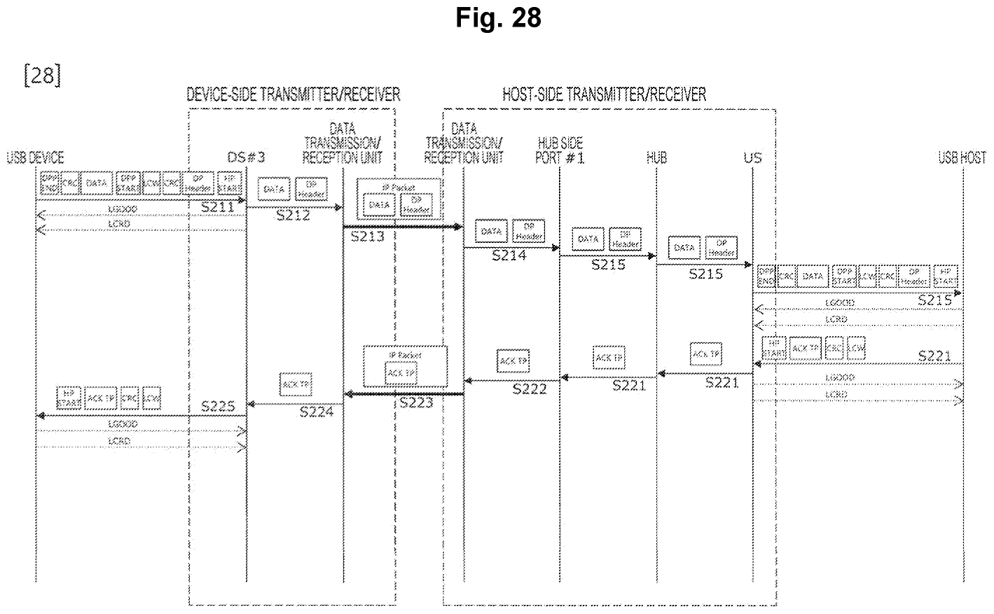

An example of a method for transmitting a packet of a protocol layer in a USB will be described with reference to FIG. 28. (In a case of IN transaction)

The DS 12 receives the USB packet from the USB device 92 (S211). Link commands of the link layer are exchanged between the USB device 92 and the device-side transmitter/receiver 91. The DS 12 passes the USB packet obtained by performing the link layer processing to the data transmission/reception unit 13 (S212).

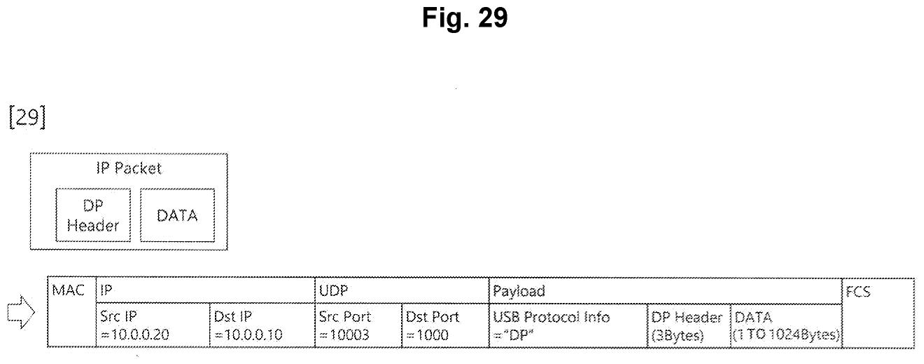

The data transmission/reception unit 13 transmits the transferred USB packet to the corresponding data transmission/reception unit 33 with which a connection has been established by a designated transmission method (IP in this example) (S213). FIG. 29 illustrates an example of the USB packet. In this event, it is described that the packet is a data packet, and the packet is transmitted while Header and DATA are separated. For example, “USB Protocol Info=“DP”” is described in a payload. As a result, the data transmission/reception unit 33 on the reception side can divide Header and DATA and pass them to the hub side port 42.

Upon receiving the data, the data transmission/reception unit 33 divides DATA and DP Header and passes the divided data and DP Header to the hub side port 42 (S214). In this event, the data transmission/reception unit 33 exchanges the link commands of the link layer with the device-side transmitter/receiver 91. The hub 41 transfers data to the USB host 96 (S215). Transfer operation of the hub side port 42 #1→the hub 41→the US 32→the USB host 96 is the same as operation of the normal hub.

The US 32 receives the USB packet from the USB host 96 (S221). Here, the transfer operation of the USB host 96→US 32→the hub 41→the hub side port 42 #1 is the same as operation of the normal hub, but it should be noted that route information to be transmitted to the hub side port 42 #1 is set in a root string of ACK TP. In other words, the set information is not the port number of the device-side transmitter/receiver 91.

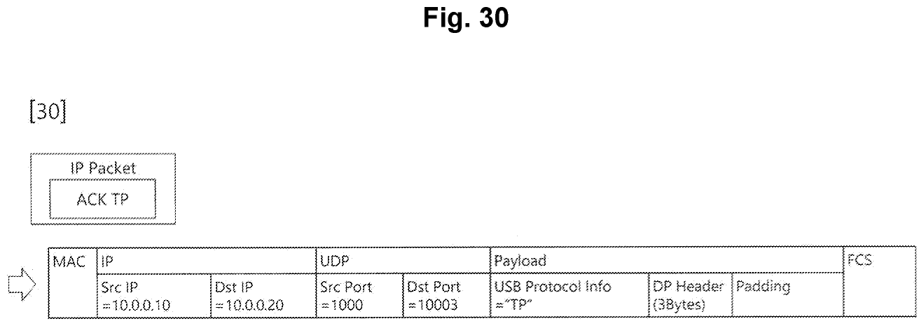

The hub side port 42 #1 passes the USB packet to the corresponding data transmission/reception unit 33 (S222). The data transmission/reception unit 33 transmits the transferred USB packet to the corresponding data transmission/reception unit 13 with which a connection has been established by a designated transmission method (IP in this example) (S223). FIG. 30 illustrates an example of the USB packet. In this event, the packet in which it is described that the packet is a transaction packet, is transmitted. For example, “USB Protocol Info=“TP”” is described in a payload. As a result, the data transmission/reception unit 13 on the reception side can pass the transaction packet to the DS 12.

Upon receiving the data, the data transmission/reception unit 13 passes the data as a transaction packet to the DS 12 (S224). The DS 12 transfers the data to the USB device 92 (S225). Here, transfer operation of the DS 12 #3→the USB device 92 is the same as operation of the DS of the normal hub.

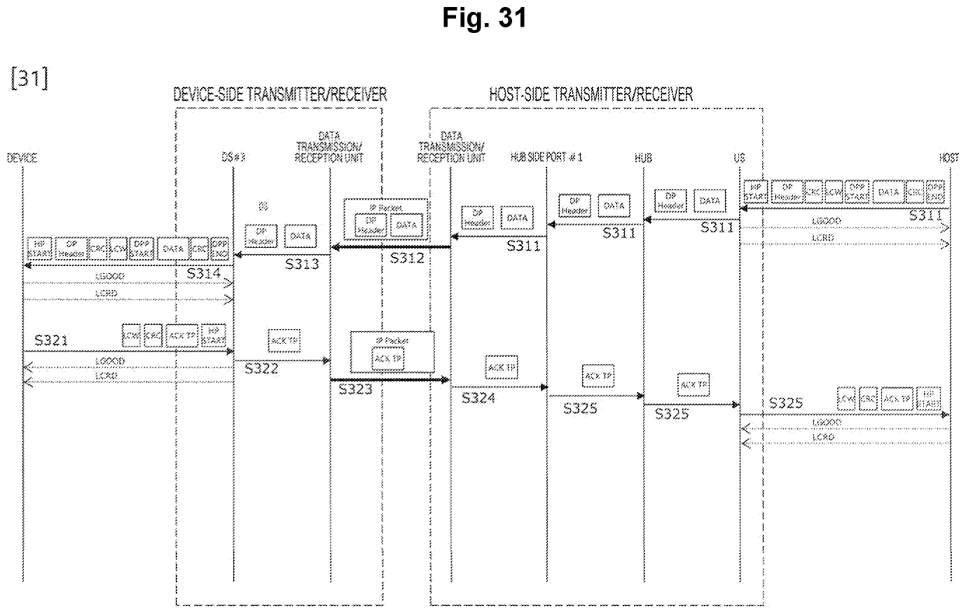

An example of a method for transmitting a packet of a protocol layer in a USB will be described with reference to FIG. 31. (In a case of OUT transaction)

The US 32 receives a USB packet from the USB host 96 (S311). Link commands of the link layer are exchanged in the device-side transmitter/receiver 91. Here, transfer operation of the USB host 96→the US 32→the hub 41→the hub side port 42 #1 is the same as operation of the normal hub. However, it should be noted that route information to be transmitted to the hub side port 42 #1 is set in a root string of ACK TP. In other words, the set information is not the port number of the device-side transmitter/receiver 91.

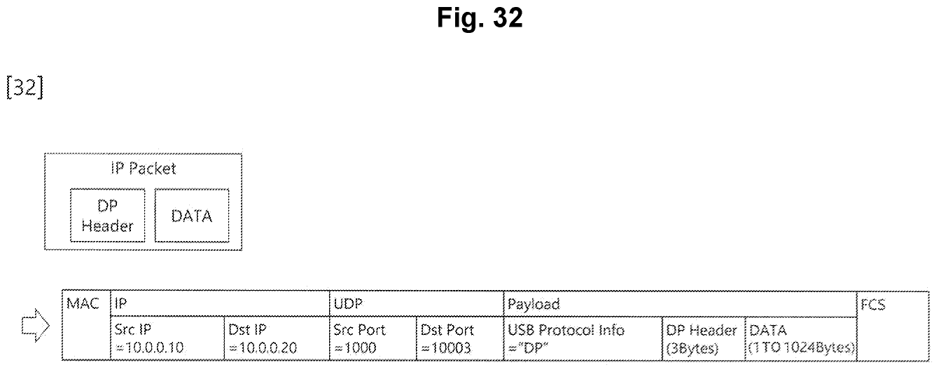

The data transmission/reception unit 33 transmits the transferred USB packet to the corresponding data transmission/reception unit 13 with which a connection has been established by a designated transmission method (IP in this example) (S312). FIG. 32 illustrates an example of the USB packet. In this event, it is described that the packet is a data packet, and the packet is transmitted while Header and DATA are separated. For example, “USB Protocol Info=“DP”” is described in a payload. As a result, the data transmission/reception unit 13 on the reception side can divide Header and DATA and pass them to the DS 12.

Upon receiving the data, the data transmission/reception unit 13 divides the DATA and the DP Header and passes the data to the DS 12 #3 (S313). The DS 12 transfers the data to the USB device 92 (S314). In this event, link commands of the link layer are exchanged in the device-side transmitter/receiver 91. Here, transfer operation of the DS 12 #3→the USB device 92 is the same as operation of the DS 12 of the normal hub.

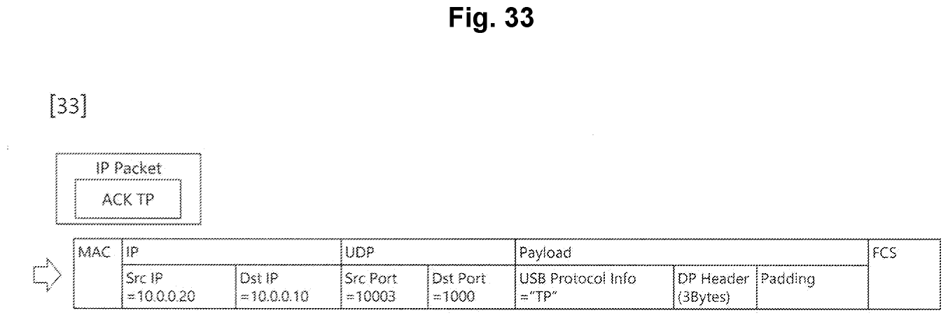

The data transmission/reception unit 13 transmits the transferred USB packet to the corresponding data transmission/reception unit 33 with which a connection has been established by a designated transmission method (IP in this example) (S323). FIG. 33 illustrates an example of the USB packet. In this event, the packet in which it is described that the packet is a transaction packet, is transmitted. For example, “USB Protocol Info=“TP”” is described in a payload. As a result, the data transmission/reception unit 33 on the reception side can pass the transaction packet to the hub side port 42.

Upon receiving the data, the data transmission/reception unit 33 passes the data to the hub side port 42 as a transaction packet (S324). Transfer operation of the hub side port 42 #1→the hub 41→the US 32→the USB host 96 is the same as operation of the normal hub.

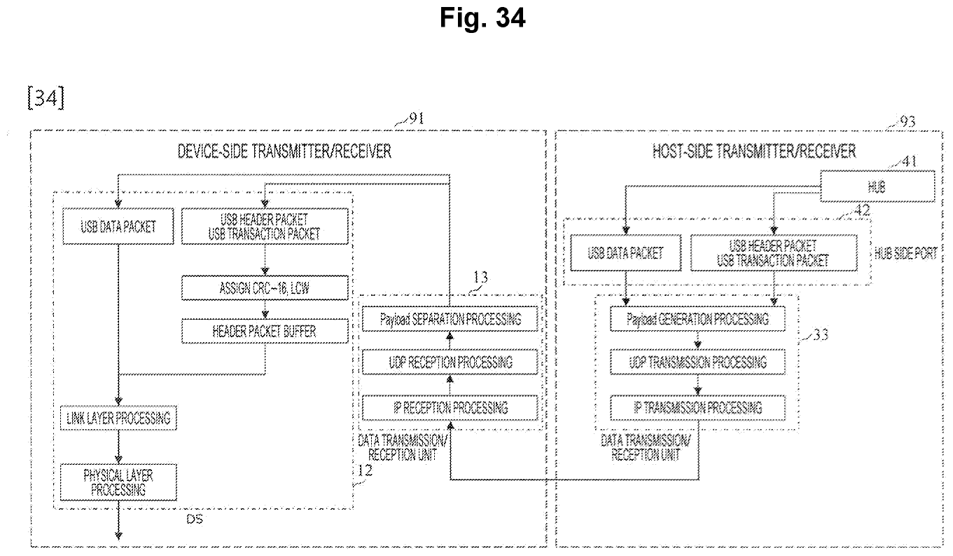

FIG. 34 illustrates an example of processing (OUT transaction) to be performed in the USB packet.

The hub side port 42 passes the USB packet transferred from the hub 41 to the data transmission/reception unit 33 as it is. The USB packet includes a USB data packet, a USB header packet, and a USB transaction packet.

The data transmission/reception unit 33 sequentially performs payload generation processing, UDP transmission processing, and IP transmission processing. In the payload generation processing, the payload to be passed to the UDP transmission processing is generated by distinguishing among the USB data packet, the USB header packet, and the USB transaction packet. In the UDP transmission processing and the IP transmission processing, normal UDP transmission processing and IP transmission processing are performed.

The data transmission/reception unit 13 sequentially performs payload separation processing, UDP reception processing, and IP reception processing. In the payload separation processing, the USB data packet, the USB header packet, and the USB transaction packet are separated. In the UDP reception processing and the IP reception processing, normal UDP reception processing and IP processing are performed.

The DS 12 separates the USB data packet, the USB header packet, and the USB transaction packet. The DS 12 assigns CRC-16 and LCW to an SB header packet and the USB transaction packet and performs header packet buffer for retransmission when a packet loss occurs in the link layer. The DS 12 performs link layer processing and physical layer processing on the USB data packet and the header packet. As a result of this, the OUT transaction is completed.

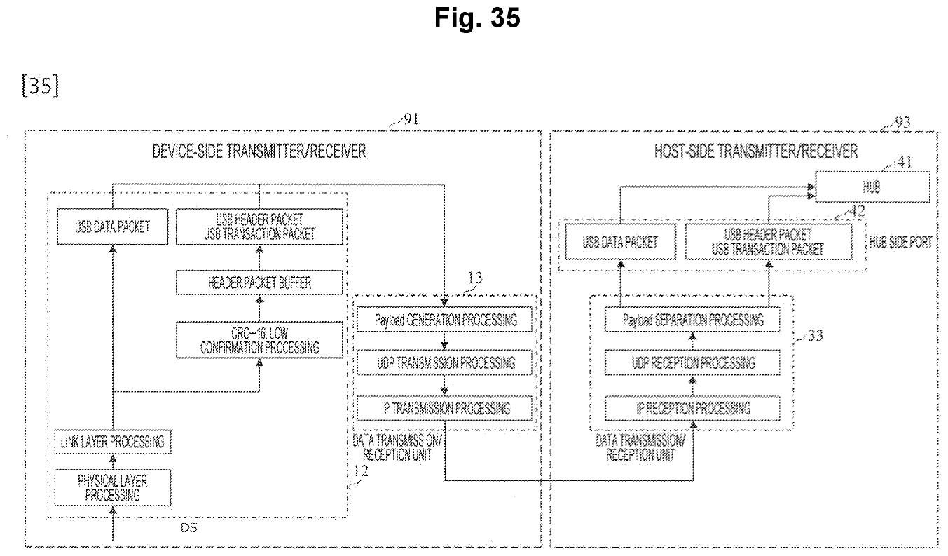

FIG. 35 illustrates an example of processing (IN transaction) to be performed in the USB packet.

The DS 12 performs physical layer processing and link layer processing. The DS 12 performs confirmation processing of the CRC-16 and the LCW, performs header packet buffer and generates a USB header packet and a USB transaction packet. Meanwhile, the DS 12 generates a USB data packet. The data transmission/reception unit 13 sequentially performs payload generation processing, UDP transmission processing, and IP transmission processing on each of these packets.

The data transmission/reception unit 33 sequentially performs IP reception processing, UDP reception processing, and payload separation processing. As a result, the USB data packet, the USB header packet, and the USB transaction packet are separated. The hub side port 42 passes each packet transferred from the data transmission/reception unit 33 to the hub 41 as it is. As a result of this, the IN transaction is completed.

The present disclosure is not limited to the modes described in the present embodiment.
UDP/IP is used as the data transmission/reception unit, but the data transmission/reception unit is not limited thereto. A technology such as Ethernet, MPLS, or OTN may be used.
The orchestrator may be configured to manage all states of the host-side transmitter/receiver and the device-side transmitter/receiver.

### INDUSTRIAL APPLICABILITY

The present disclosure can be applied to information communication.

### REFERENCE SIGNS LIST

11 USB port
12 DS
13, 33 Data transmission/reception unit
14 Control transmission/reception unit
15 DS Controller
16 Device-side transmitter/receiver control unit
17 Device-side connection information management unit
18 DS status management unit
32 US
34 Control transmission/reception unit
35 US Controller
36 Host-side transmitter/receiver control unit
37 Host-side connection information management unit
41 Hub
42 Hub side port
43 Hub controller
51 Connection request acceptance unit
52 Transmitter/receiver instruction unit
53 Transmitter/receiver information management unit
81 Data network
82 Control network
91 Device-side transmitter/receiver
92 USB device
93 Host-side transmitter/receiver
94 Server
95 Orchestrator
96 USB host

1. A USB transmission system, comprising:
a device-side transmitter/receiver including a USB port connectable to a USB device; and
a host-side transmitter/receiver connectable to a USB host,
wherein each of the device-side transmitter/receiver and the host-side transmitter/receiver includes a data transmission/reception unit configured to transmit/receive a packet of a USB protocol layer via a data network, and
the host-side transmitter/receiver includes a hub configured to transfer data to be transmitted/received by the data transmission/reception unit included in the host-side transmitter/receiver to the USB host.

2. The USB transmission system according to claim 1, further comprising:
an orchestrator configured to manage a connection relationship between the device-side transmitter/receiver and the host-side transmitter/receiver,
wherein the device-side transmitter/receiver comprises:
a downstream (DS) function unit configured to transmit/receive data to/from a USB device for each USB port; and
a DS controller configured to cause the DS function unit to operate as at least one DS port of the host-side transmitter/receiver according to an instruction from the orchestrator.

3. The USB transmission system according to claim 2,
wherein the device-side transmitter/receiver and the host-side transmitter/receiver
exchange with each other and with the orchestrator via a control network, at least one of:
a connection state with a USB host in the host-side transmitter/receiver;
a connection state with a USB device in the device-side transmitter/receiver; and
a connection establishment state between the host-side transmitter/receiver and the device-side transmitter/receiver,
the device-side transmitter/receiver determines operation of the DS function unit and the data transmission/reception unit on the basis of the exchanged state, and
the host-side transmitter/receiver determines operation of the data transmission/reception unit on the basis of the exchanged state.

4. The USB transmission system according to claim 1,
wherein if the device-side transmitter/receiver receives a USB packet from a USB device, the device-side transmitter/receiver converts header information and data described in the USB packet received from the USB device into a USB packet stored in a payload with the data transmission/reception unit of the host-side transmitter/receiver defined for each downstream (DS) function unit that transmits/receives data to/from the USB device as a destination, and
if the device-side transmitter/receiver receives a USB packet from the data transmission/reception unit of the host-side transmitter/receiver, the device-side transmitter/receiver acquires header information and data from a payload of the USB packet and converts the header information and the data into a USB packet to the USB device.

5. A USB transmission apparatus comprising:
a USB port connectable to a USB device;
a downstream (DS) function unit configured to transmit/receive data to/from a USB device connected to the USB port; and
a data transmission/reception unit configured to perform transmission/reception with a host-side transmitter/receiver connected to a USB host via a data network,
wherein if the DS function unit receives data from the USB device, the data transmission/reception unit generates a packet of a USB protocol layer storing the data and transmits the packet to the host-side transmitter/receiver, and
if the DS function unit receives a packet of a USB protocol layer from the host-side transmitter/receiver, the data transmission/reception unit transfers data stored in the packet to the DS function unit.

6. A USB transmission apparatus comprising:
an upstream (US) function unit configured to transmit/receive data to/from a USB host;
a data transmission/reception unit configured to perform transmission/reception with a device-side transmitter/receiver provided with a USB port connectable to a USB device via a data network,
wherein if the US function unit receives data from the USB host, the data transmission/reception unit generates a packet of a USB protocol layer storing the data and transmits the packet to the device-side transmitter/receiver, and
if the US function unit receives a packet of a USB protocol layer from the device-side transmitter/receiver, the data transmission/reception unit transfers data stored in the packet to the US function unit.

7. (canceled)

8. A non-transitory computer-readable medium having computer-executable instructions that, upon execution of the instructions by a processor of a computer, cause the computer to function as the USB transmission apparatus according to claim 5.
